(19) United States
(12) Patent Application Publication
(10) Pub. No.: US 2010/0289943 A1
(43) Pub. Date: Nov. 18, 2010

(54) BROADCASTING RECEIVER

(75) Inventors: Kenichi Tokoro, Kanagawa-ken (JP); Takashi Seki, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/717,589

(22) Filed: Mar. 4, 2010

(30) Foreign Application Priority Data
May 14, 2009 (JP) 2009-117852

(51) Int. Cl. H04N 11/02

(52) U.S. Cl. 348/425.2; 348/432.1; 348/E11.006; 348/563

(57) ABSTRACT

A broadcasting receiver includes a demodulator, a detector, and a start flag storage unit. The demodulator demodulates received digital broadcasting and outputs a demodulated signal. The signal detector detects a synchronization signal and a start control signal from the demodulated signal. The synchronization signal and the start control signal are contained in an emergency alert broadcasting frame multiplexed onto the digital broadcasting. The start control signal indicates emergency alert broadcasting. The start flag storage unit stores a start flag indicating that the signal detector has detected the start control signal.

### CROSS REFERENCE TO RELATED APPLICATION

This application is based upon and claims the benefit of priority from the prior Japanese Patent Application No. 2009-117852, filed on May 14, 2009, the entire contents of which are incorporated herein by reference.

### FIELD OF THE INVENTION

The invention relates to a broadcasting receiver capable of receiving emergency alert broadcasting.

### DESCRIPTION OF THE BACKGROUND

Implementation of digital television broadcasting has started. The digital television broadcasting in Japan employs ISDB-T standard. In ISDB-T standard, a transport stream (TS) specified in the standard of Moving Picture Experts Group (MPEG) 2 undergoes various signal processings such as error-correcting coding, interleave coding, and digital modulation to produce a broadcast signal. Then, the broadcast signal is modulated by Orthogonal Frequency Division Multiplexing (OFDM) and then is broadcasted.

In the Orthogonal Frequency Division Multiplexing (OFDM) scheme, wideband signals are transmitted by use of multiple subcarriers that are orthogonal to one another. For this reason, the OFDM scheme is advantageous in that the OFDM scheme has, as one of essential transmission conditions for the terrestrial television broadcasting, an ability to improve delay interference characteristics in the multipath propagation paths.

In a frequency domain of the ISDB-T standard, a single block includes OFDM symbols of 108 carriers. A single segment includes a single block, two blocks, or four blocks, depending on the mode. Accordingly, the number of carriers for each single segment is 108 in the case of a single block, 216 in the case of two blocks, or 432 in the case of four blocks. According to the ISDB-T standard, the transmission of signals is performed using a bandwidth for 13 segments. In addition, in a time domain of the ISDB-T standard, a single frame includes 204 OFDM symbols. The TS-transmission and the energy dispersion processing are performed frame by frame. In addition, the ISDB-T standard can provide a hierarchical transmission, in which plural layers of different transmission characteristics are transmitted simultaneously. Each layer includes one or plural OFDM segments. Parameters, such as the carrier modulation scheme, the coding ratio of inner coding, and the time interleave length, can be specified for each layer.

Information on such a layer and a frame synchronization signal are transmitted by transmission control signals (TMCC: Transmission and Multiplexing Configuration Control). TMCC is inserted into each block of OFDM symbols. In addition, a Scattered Pilot (SP) and a Continuous Pilot (CP) to estimate a frequency response of a transmission path are also inserted into an OFDM frame. Furthermore, Auxiliary Controls 1, 2 (AC1, AC2) are to be inserted into the OFDM frame. AC1 and AC2 are symbols to transmit additional information which a broadcaster can use to transmit special information, for example.

In recent years, receivers for digital terrestrial broadcasting or One seg broadcasting have been very widely used. Use of the digital broadcasting to transmit an emergency alert broadcast publicizing occurrence of a disaster can be anticipated as a prompt and accurate way of publicity.

One of such techniques to perform the emergency alert broadcasting is disclosed in JP-A2008-148230(KOKAI). In the technique of the literature, a broadcasting station assigns segments, which are assigned data broadcasting in the digital broadcasting, to data for emergency alert broadcasting of emergency alert data, and then transmits the data for emergency alert broadcasting.

In the technique of Japanese Patent Application Publication No. 2008-148230, however, it is only viewers who are viewing data broadcasting with digital broadcasting receivers that can obtain information of the emergency alert broadcasting. Specifically, the emergency alert broadcasting is provided to viewers by a telop announcing occurrence of a disaster and being displayed running on the screen of a TV program or by a changeover of a program on the air to a news program.

Thus, viewers whose digital broadcasting receivers are out of operation for providing video and sound of broadcasting are not promptly notified of the content of the emergency alert broadcasting.

It is an object of the invention to provide a broadcasting receiver capable of promptly providing emergency alert broadcasting to viewers by detecting start of emergency alert broadcasting within a short period of time.

According to the invention, detection that emergency alert broadcasting has started can be made in a short period of time. Thus, the invention has an effect that emergency alert broadcasting can be promptly provided to viewers.

### SUMMARY OF THE INVENTION

According to one aspect of the invention, a broadcasting receiver includes:
a demodulator to demodulate received digital broadcasting and to output a demodulated signal;
a signal detector to detect a synchronization signal and a start control signal from the demodulated signal, the synchronization signal and the start control signal contained in an emergency alert broadcasting frame multiplexed onto the digital broadcasting, the start control signal indicating emergency alert broadcasting; and
a start flag storage unit to store a start flag indicating that the signal detector has detected the start control signal.

According to other aspect of the invention, a broadcasting receiver includes:
a demodulator to demodulate digital broadcasting and to output a demodulated signal;
a signal detector to detect a synchronization signal and a start control signal from the demodulated signal, the synchronization signal and the start control signal contained in an emergency alert broadcasting frame multiplexed onto the digital broadcasting, the start control signal indicating emergency alert broadcasting;
a start flag storage unit to store a start flag indicating that the start control signal has been detected;
an error correction unit to perform error detection and correction of the emergency alert broadcasting data contained in the emergency alert broadcasting frame received through the signal detector;
a data storage unit to store the emergency alert broadcasting data having been error-corrected on the basis of error detection by the error correction unit; and
a controller to multiplex the emergency alert broadcasting data, read from the data storage unit, onto the demodulated signal to obtain a multiplexed data, and to output the multiplexed data, when reading the start flag from the start flag storage unit.

According to other aspect of the invention, a broadcasting receiver includes:
a signal detector to detect a synchronization signal and a start control signal from a signal obtained by demodulating digital broadcasting, the synchronization signal and the start control signal contained in an emergency alert broadcasting frame multiplexed onto the digital broadcasting, the start control signal indicating emergency alert broadcasting;
a start flag storage unit readable from an external unit, the start flag storage unit configured to store a start flag indicating that the start control signal has been detected;
an error correction unit to perform error detection and correction of the emergency alert broadcasting data contained in the emergency alert broadcasting frame received through the signal detector; and
a data storage unit readable from an external unit, the data storage unit configured to store the emergency alert broadcasting data having been error-corrected on the basis of error detection by the error correction unit.

### BRIEF DESCRIPTION OF THE DRAWINGS

FIG. 1 is a block diagram showing a broadcasting receiver according to a first embodiment of the invention;

FIG. 2 is an illustration showing a configuration of an OFDM frame with the horizontal axis indicating Carrier Number (frequency domain) and the vertical axis indicating Symbol Number (time domain);

FIG. 3 is a flowchart for showing the operation of the first embodiment;

FIG. 4 is a block diagram of a second embodiment of the invention;

FIG. 5 is a block diagram showing a third embodiment of the invention;

FIG. 6 is an illustration for showing a timing lag between an OFDM frame from a demodulator 16 and an error corrected OFDM frame from a decoder 17;

FIG. 7 is a block diagram showing a specific configuration of a multiplexer 41 in FIG. 5; and

FIG. 8 is a timing chart for showing the operation of a circuit in FIG. 7.

### DETAILED DESCRIPTION OF THE INVENTION

Embodiments of the invention will be described hereinafter in detail with reference to the drawings.

### Description of the First Embodiment

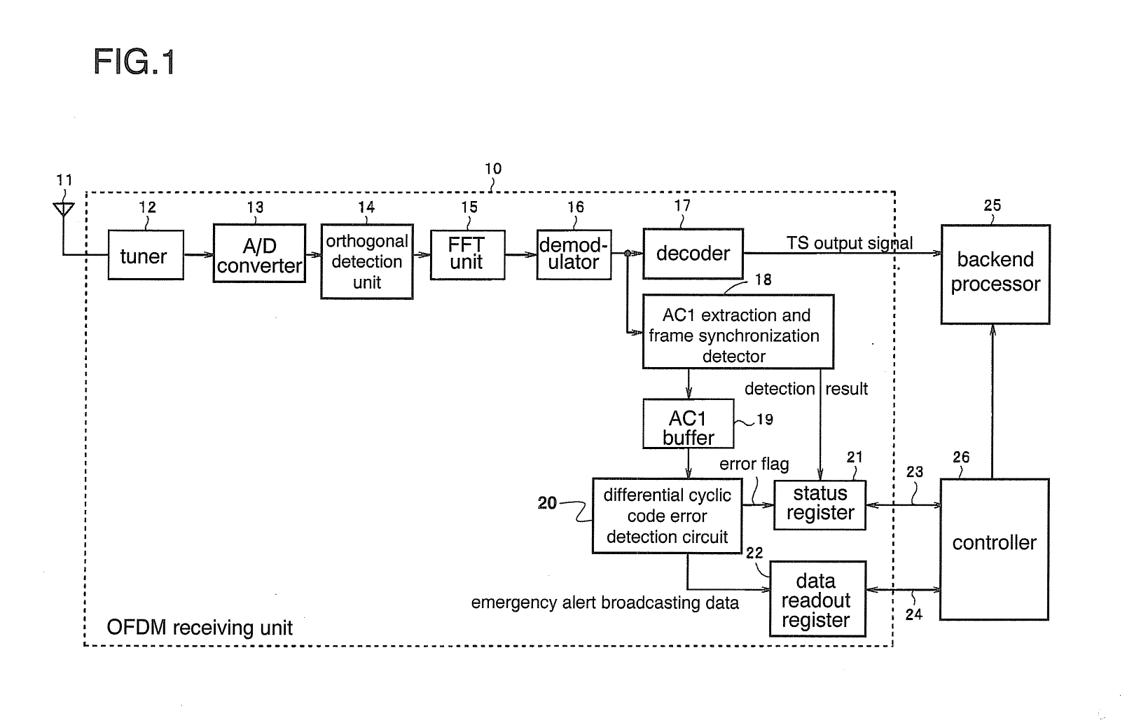

FIG. 1 is a block diagram showing a broadcasting receiver according to a first embodiment of the invention.

It is currently proposed in ISDB-T standard that data for emergency alert broadcasting is placed in and transmitted with AC1 (Auxiliary Control) in an OFDM frame. The embodiment will be described on the assumption that the data for emergency alert broadcasting is placed in AC1.

In FIG. 1, a digital broadcast signal received by an antenna 11 is supplied to a tuner 12 in an OFDM receiving unit 10. The tuner 12 selects a signal for a predetermined channel from the received signal, and outputs the selected signal to an A/D converter 13. The A/D converter 13 converts the output from the tuner 12 into a digital signal, and outputs the converted signal to an orthogonal detection unit 14. The orthogonal detection unit 14 orthogonally detects the output from the A/D converter 13, and thus obtains an OFDM signal of baseband. The OFDM signal is supplied to an FFT unit 15.

After removing a guard interval from the OFDM signal of the baseband, the FFT unit 15 converts an OFDM signal in the time domain into an OFDM signal in the frequency domain, by FFT (Fast Fourier Transform) process. With this, a symbol data stream (OFDM symbols) showing a phase and amplitude of each carrier of the OFDM signal is obtained. The OFDM symbol is supplied to the demodulator 16.

The demodulator 16 restores original data from the inputted OFDM symbol. For example, the demodulator 16 extracts a transmission mode signal from the inputted OFDM symbol and determines the mode information for the inputted OFDM symbol. Then, according to the determination result, the demodulator 16 performs synchronization detection or delay detection and restores the original data. Specifically, if the transmission mode is the synchronization detection, the demodulator 16 performs amplitude and phase equalization on the OFDM symbol by using a pilot signal in the OFDM frame, and obtains layered information and equalized restored data for the OFDM symbol. In addition, if the transmission mode is the delay detection, the demodulator 16 obtains layered information and equalized data on the OFDM symbol by detecting an error in each carrier by use of the prior and the following symbols, and performing amplitude and phase equalization for the OFDM symbol. An output of the demodulator 16 is supplied to the decoder 17. The decoder 17 restores the signal transmitted by the OFDM signal, by performing error correction processing by use of inner and outer codes provided by the transmitting side, and by performing de-interleave processing. An output from the decoder 17 is a Transport Stream (TS) output signal of the Moving Picture Experts Group (MPEG) 2. Here, convolution coding processing and RS coding processing or the like are employed as inner coding processing and outer coding processing. Although the convolution coding processing and the RS coding processing have been taken as examples, coding processing is not limited to the convolution coding processing and the RS coding processing.

The TS output signal from the decoder 17 is provided to a backend processor 25 external to the OFDM receiving unit 10. The backend processor 25 may be an MPEG decoder or the like, for example. The backend processor 25 decodes the inputted TS output signal, retrieves and outputs video and audio signals of broadcasting content.

The output from the demodulator 16 is also supplied to an AC1 extraction and frame synchronization detector 18 (signal detector). The AC1 extraction and frame synchronization detector 18 extracts AC1 (Auxiliary Control) inserted into every OFDM frame from the output of the demodulator 16.

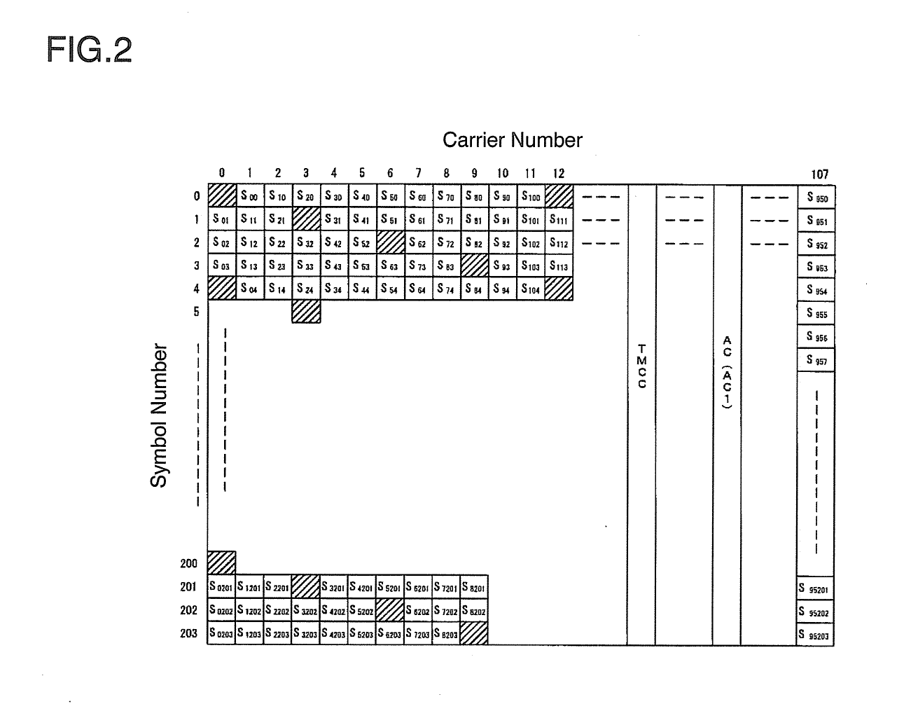

FIG. 2 is a diagram showing a configuration of the OFDM frame with the horizontal axis indicating Carrier Number (frequency domain) and the vertical axis indicating Symbol Number (time domain). FIG. 2 is the diagram shown in STD-B31 “Digital Terrestrial Television Broadcasting Transmission System” of ARIB (Association of Radio Industries and Business) standard. FIG. 2 is an example employing QAM modulation as a modulation system. As shown in FIG. 2, 1 carrier for each frame is used for transmission of TMCC. In addition, shaded areas in FIG. 2 represent SP (Scattered Pilot) symbols.

In addition, Table 1 below shows a configuration of the AC1 (B0 to B203) of 204 bits in the OFDM frame, the AC1 constituting an emergency alert broadcasting frame.

TABLE 1

| | Number | |
|---|---|---|
| Bit Number | of bits | Content |
| B0 | 1 | Differential Modulation Reference |
| B1 to B3 | 3 | Configuration Identification Signal |
| B4 to B16 | 13 | Synchronization Signal (Frame |
| | | Synchronization Signal) |
| B17 to B18 | 2 | Emergency Start Flag (Start Control |
| | | Signal) |
| B19 to B121 | 103 | Emergency Information (Emergency |
| | | Alert Broadcasting Data) |
| B122 to | 82 | Parity Bit (Differential Cyclic Error |
| B203 | | Correction) |

The AC1 completes in 1 OFDM frame. As shown in Table 1, the AC1 includes 82 bits of parity bits (B122 to B203) for differential cyclic error correction at the end of data. In addition, as shown in Table 1, the AC1 data includes 1 bit of differential modulation reference signal (B0), 3 bits of configuration identification signals (B1 to B3), 13 bits of synchronization signals (frame synchronization signals) (B4 to B16), 2 bits emergency start flags (start control signals) (B17 to B18), and 103 bits of emergency information (emergency alert broadcasting data) (B19 to B121), in ascending order of OFDM symbol numbers.

The AC1 extraction and frame synchronization detector 18 detects a frame synchronization signal from the extracted AC1. Here, the 13 bits of frame synchronization signal patterns of B4 to B16 of the AC1 are w0=1010111101110/w1=0101000010001. That is to say, the AC1 extraction and frame synchronization detector 18 detects a pattern which is identical to a pattern specified by B4 to B16 of Table 1, as a synchronization signal, from each bit of AC1 in the OFDM frame. The AC1 extraction and frame synchronization detector 18 outputs AC1 data for the extracted one OFDM frame to an AC1 buffer 19.

When AC1 data is accumulated in the AC1 buffer 19, a differential cyclic code error detection circuit 20 (an error correction unit) performs error detection and correction processing of the AC1 data, using parity bits. The emergency alert broadcasting data (B19 to B121) is contained in the AC1 data, and the differential cyclic code error correction circuit 20 stores the emergency alert broadcasting data after error detection in a data readout resister 22 (a data storage unit). That is to say, if there is no error, the received emergency alert broadcasting data is directly stored in the data readout register 22. In contrast, if there is any error, the emergency alert broadcasting data having the error corrected by the differential cyclic code error correction circuit 20 is stored.

A status register 21 is designed to store a start flag showing a detection result that the emergency alert broadcasting data was transmitted by the AC1 data (as a start flag storage unit), and an error flag showing error judgment result of the AC1 data (as an error flag storage unit).

In the embodiment, the start flag of the status register 21 is updated by the AC1 extraction and frame synchronization detector 18. In addition, the error flag of the status register 21 is updated by the differential cyclic error correction circuit 20. That is to say, when detecting the synchronization signals of B4 to B16 and the start control signals of B17 to B18, the AC1 extraction and frame synchronization detector 18 outputs a signal showing the detection result of the start control signal to the status register 21, without detecting all data of AC1. The start flag of the status register 21 is “1”, for example, when the start control signal is detected, and remains “0” when the start control signal is not detected.

In addition, the differential cyclic error correction circuit 20 outputs error judgment result of whether or not the AC1 data has an error, to the status register 21. For example, according to error judgment result of the differential cyclic error correction circuit 20, the error flag of the status register 21 indicates “0” when the AC1 data has an error, and “1” when the AC data does not have an error.

Usually, in order to utilize the AC1 data, all data of the AC1 for a OFDM frame needs to be extracted and subjected to error detection and correction. Therefore, in a conventional manner, detection that the emergency alert broadcasting was performed is not made at least during reception of an entire OFDM frame, after the reception of the emergency alert broadcasting is started.

In contrast, in the embodiment, after capturing 19 bits from B0 to B18 in advance, the AC1 extraction and frame synchronization detector 18 can detect that the emergency alert broadcasting was performed before the error correction processing is performed. Thus, the AC1 extraction and frame synchronization detector 18 can output detection result of the start control signal in an extremely short period after the emergency alert broadcasting starts.

The status register 21 and the data readout register 22 are respectively connected to a controller 26 provided external to the OFDM receiving unit 10 by way of data busses 23, 24. Here, the controller 26 can be configured by a microcomputer. The controller 26 reads out a start flag and an error flag from the status register 21, and reads emergency alert broadcasting data from the data readout register 22. In addition, the controller 26 can control a power source of the backend processor 25 or the like, on the basis of the start flag and the error flag.

For example, consider a case where a main power source of a television receiver in which the device of FIG. 1 is embedded is turned off, power supply to the decoder 17 and the backend processor 25 is stopped, and power is supplied to other portions of the circuit in FIG. 1 by a sub-power source. Even when the main power source is turned off, if the controller 26 reads the start flag “1”, for example, of the status register 21, the controller 26 controls so that power is supplied to the decoder 17 and the backend processor 25 to allow the decoder 17 and the backend processor 25 to be activated.

In addition, when reading the error flag “1” (indicating that there is no error) of the status register 21, the controller 26 reads emergency alert broadcasting data from the data readout register 22 and performs processing based on the read emergency alert broadcasting data.

In addition, if the controller 26 reads the error flag “0” (indicating that there is an error) of the status register 21, even if the start flag is “1”, the controller 26 suspends power supply to the decoder 17 and the backend processor 25 that the controller 26 has once started to operate, and stops the operations of the decoder 17 and the backend processor 25.

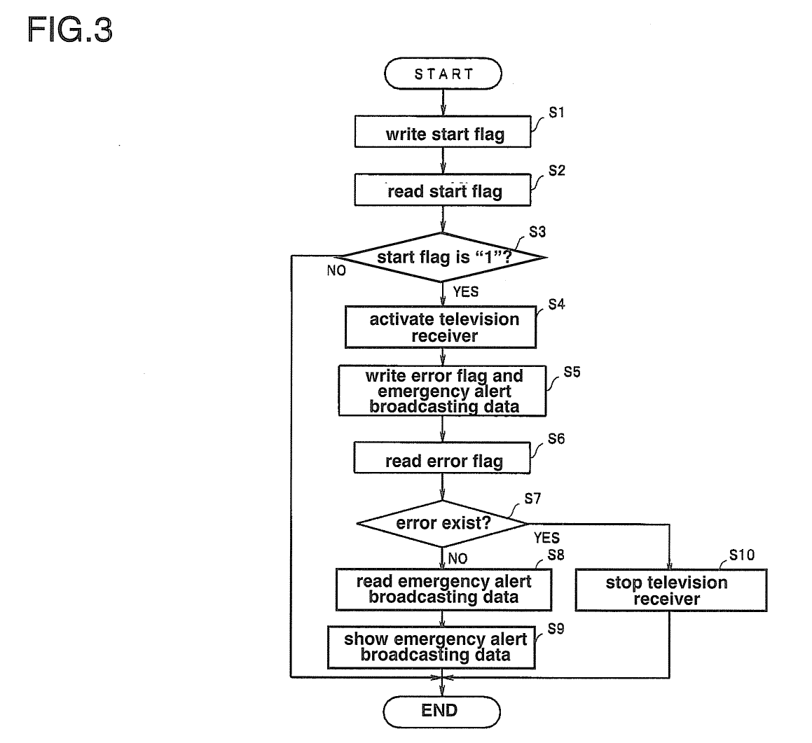

The operation of the embodiment thus configured will be described hereinafter with reference to the flowchart of FIG. 3.

As operating state of the television receiver in which the device of FIG. 1 is embedded, even when the main power source is turned off, the other portions of the circuit excluding the decoder 17 and the backend processor 25 are supplied with supply voltage from the sub-power source, and thus are active at all times.

Now assume that the main power source is turned off. Even in this case, a digital broadcast signal received by the antenna is supplied to the tuner 12 so that a signal for a predetermined channel is received. The A/D converter 13 receives output of the tuner 12 and converts the output into a digital signal. Then, the digital signal is supplied to the orthogonal detector 14. In the orthogonal detector 14, an OFDM signal of a baseband is obtained from the received signal, and supplied to the FFT unit 15.

The FFT unit 15 removes a guard interval from the OFDM signal of the baseband, and converts the OFDM signal in time domain into an OFDM symbol in frequency domain by the FFT (Fast Fourier Transform) processing. The OFDM symbol is supplied to the demodulator 16. The demodulator 16 restores original data from the inputted OFDM symbol. The OFDM frame is supplied from the demodulator 16 to the decoder 17. The decoder 17 outputs a TS output which is obtained by subjecting an output of the demodulator 16 to the error correction processing and the de-interleave processing.

Now assume that as a result of occurrence of a disaster or the like, a broadcasting station inserts emergency alert broadcasting data into AC1 in an OFDM frame and transmits the data in the AC1. The OFDM frame from the demodulator 16 is also supplied to the AC1 extraction and frame synchronization detector 18. The AC1 extraction and frame synchronization detector 18 extracts the AC1 data from the OFDM frame, and first detects the frame synchronization signal patterns (B4 to B16). The AC1 extraction and frame synchronization detector 18 further detects the start control signals (B17, B18). When detecting the start control signals, the AC1 extraction and frame synchronization detector 18 immediately outputs the detection result of the start control signals to the status register 21. Accordingly, the start flag of the status register 21 is rewritten from “0” to “1” (Step S1).

The controller 26 reads content of the status register 21 at predetermined timing by way of the data bus 23 (Step S2). When detecting that the read start flag has been updated to “1” (Step S3), the controller 26 performs such a control that supply voltage is supplied to the decoder 17 and the backend processor to automatically activate the television receiver. Accordingly, the television receiver is activated in an extremely short period of time after the emergency alert broadcasting starts (Step S4).

On the one hand, the AC1 extraction and frame synchronization detector 18 continues to extract AC1 and stores AC1 data for an OFDM frame in the AC1 buffer 19. When the AC1 data is stored in the AC1 buffer 19, the differential cyclic error correction circuit 20 performs error detection and correction processing. The differential cyclic error correction circuit 20 outputs the error detection result to the status register 21. At the same time, the differential cyclic error correction circuit 20 outputs the emergency alert broadcasting data which has been subjected to the error correction processing on the basis of the error detection result, to the data readout register 22 (Step S5).

The controller 26 reads the error flag of the status register 21 (Step S6). When reading the error flag “1” (Yes in Step S7), the controller 26 judges that the AC1 data has an error. In this case, for example, the controller 26 suspends power supply to the decoder 17 and the backend processor 25 to stop the operation of the television receiver (Step S10).

When the controller 26 reads the error flag “0” (No in Step S7), the controller 26 judges that the AC1 data has no error, and reads the emergency alert broadcasting data from the data readout register 22 (Step S8). The controller 26 controls the backend processor 25 so that presentation is made to a user on the basis of the read emergency alert broadcasting data (Step S9).

Thus, in the embodiment, the AC1 extraction and frame synchronization detector 18 can detect a start control signal in an extremely short period of time from the start of the emergency alert broadcasting. Specifically, time of a OFDM frame (200 milliseconds) is originally needed for making judgment on the emergency alert broadcasting. However, according to the embodiment, the AC1 extraction and frame synchronization detector 18 can make a judgment within approximately 18 milliseconds for reading 19 symbols. In addition, since the controller 26 reads the start flag based on detection of the start control signal, the television receiver can be automatically activated even when the main power source is turned off. Therefore, presentation of the emergency alert broadcasting to viewers can be made. With this, even when the main power source is turned off, the receiver can be activated in an extremely short period of time from the start of the emergency alert broadcasting, thereby presenting the emergency alert broadcasting to the viewers.

### Description of the Second Embodiment

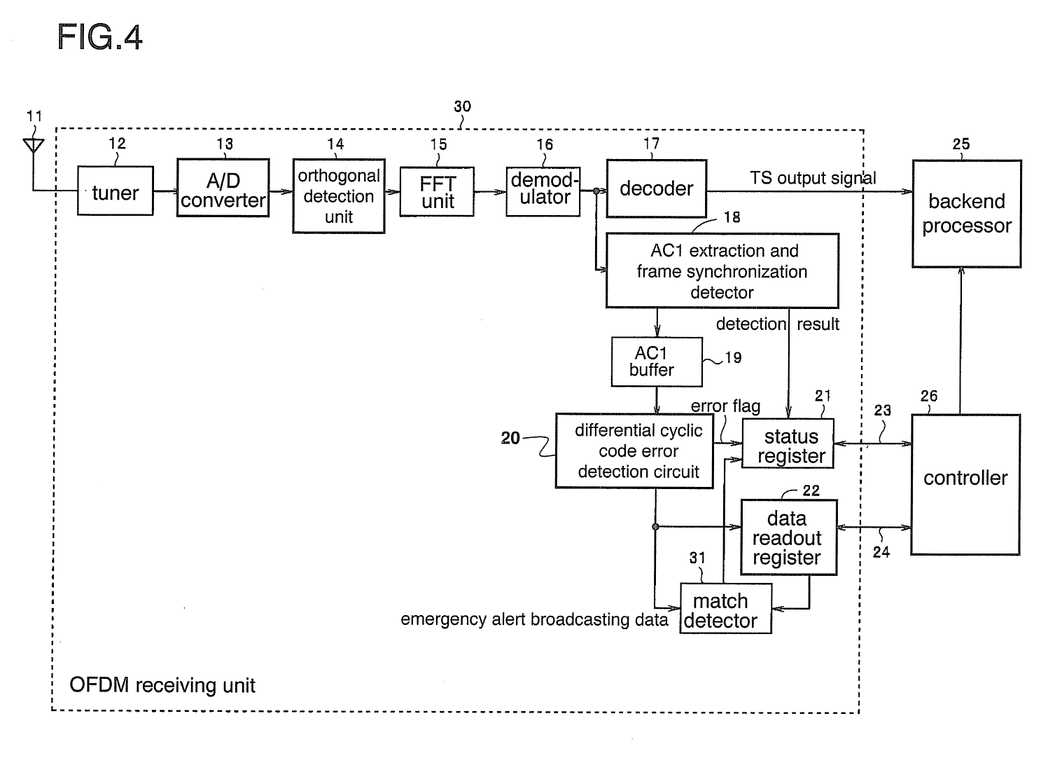

FIG. 4 is a block diagram showing a second embodiment of the invention. In FIG. 4, the same reference numerals are given to the same portions as FIG. 1, and the description of the same portions is omitted.

The embodiment differs from the first embodiment in that an OFDM receiving unit 30 to which a match detector 31 is added is employed. Emergency alert broadcasting data from the differential cyclic error correction circuit 20 is given to the match detector 31. In addition, emergency alert broadcasting data stored in the data readout register 22 is also given to the match detector 31. The match detector 31 detects whether or not the emergency alert broadcasting data from the differential cyclic error correction circuit 20 perfectly matches the emergency alert broadcasting data from the data readout register 22. That is to say, the match detector 31 is designed to detect whether or not the emergency alert broadcasting data has been updated, and to output the detection result to the status register 21.

The status register 21 holds a start flag and an error flag, as with the first embodiment. Furthermore, the status register 21 holds an update flag based on the detection result of the match detector 31. The controller 26 reads the update flag and detects a mismatch between the emergency alert broadcasting data from the differential cyclic error correction circuit 20 and the emergency alert broadcasting data from the data readout register 22. That is to say, only when the update flag has been updated (a mismatch has been detected), the controller 26 reads out the emergency alert broadcasting data stored in the data readout register 22.

In the embodiment thus configured, the match detector 31 outputs the detection result showing whether or not the emergency alert broadcast data has been updated, to the status register 21. With this, the status register 21 holds the update flag showing whether or not the emergency alert broadcasting data has been updated.

The controller 26 accesses the status register 21 at predetermined timing, and reads a start flag, an error flag, and an update flag. When the controller 26 reads the start flag “1” and the error flag “0”, it reads the emergency alert broadcasting data stored in the data readout register 22.

Since the emergency alert broadcasting data is likely to be updated momentarily, the controller 26 needs to check the emergency alert broadcasting data regularly. Since the minimum update time of the emergency alert broadcasting data is a period of one OFDM frame, the controller 26 only has to read out the emergency alert broadcasting data for every OFDM frame.

The emergency alert broadcasting data is, however, not always updated for each OFDM frame, and the controller 26 may read the data unnecessarily. Thus, in the embodiment, the controller 26 reads the emergency alert broadcasting data from the data readout register 22 at the timing when the update flag is updated.

When the emergency alert broadcasting data is updated after 10 OFDM frames, for example, the controller 26 performs readout from the data readout register 22 only once every 10 OFDM frames after the last update. That is to say, the controller 26 only has to perform readout from the data readout register 22 for the number of times 1/10 of the number of frames. This can prevent unnecessary readout by the controller 26.

Thus, the embodiment has advantages not only that the embodiment achieve the similar effect to the first embodiment, but also that the embodiment can prevent the controller 26 from reading out data unnecessarily.

### Description of the Third Embodiment

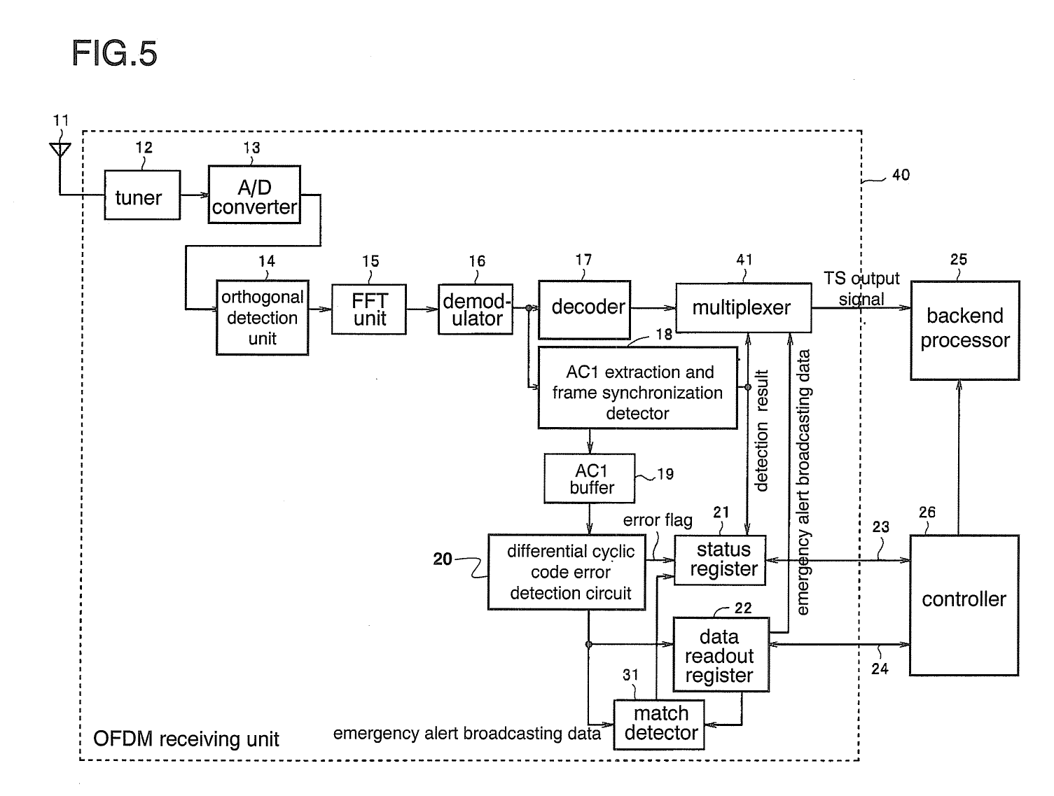

FIG. 5 is a block diagram showing a third embodiment of the invention. In FIG. 5, the same reference numerals are given to the same portions as FIG. 4, the description of the same portions is omitted.

The third embodiment differs from the second embodiment in that the third embodiment has employed an OFDM receiving unit 40 to which a multiplexer 41 is added. The multiplexer 41 receives a TS output from a decoder 17, detection result of a start control signal from an AC1 extraction and frame synchronization detector 18, and emergency alert broadcasting data from a data readout register 22. When the AC1 extraction and frame synchronization detector 18 notifies the multiplexer 41 that the start control signal was detected, the multiplexer 41 reads out the emergency alert broadcasting data from the data readout register 22. Then, the multiplexer 41 multiplexes the emergency alert broadcasting data to the TS output signal from the decoder 17, and outputs multiplexed data to a backend processor 25.

The TS output signal is outputted for each packet of 204 bytes. Leading 188 bytes of the 204 bytes are a data portion, and last 16 bytes are a parity period in which the parity is arranged. The multiplexer 41 is designed to multiplex the emergency alert broadcasting data onto the parity period of the TS output signal, for example, and output the multiplexed data.

In the embodiment thus configured, when the emergency alert broadcasting starts, a TS output obtained by multiplexing the emergency alert broadcasting data onto the parity period of the TS output signal from the decoder 17 is outputted.

With this, the backend processor 25 can obtain the emergency alert broadcasting data, without the readout operation of the emergency alert broadcasting data by the controller 26.

Meanwhile, output from the demodulator 16 is an OFDM frame. The data of an OFDM frame from the demodulator 16 has been interleaved, and the decoder 17 obtains a TS output signal by de-interleaving data of multiple OFDM frame.

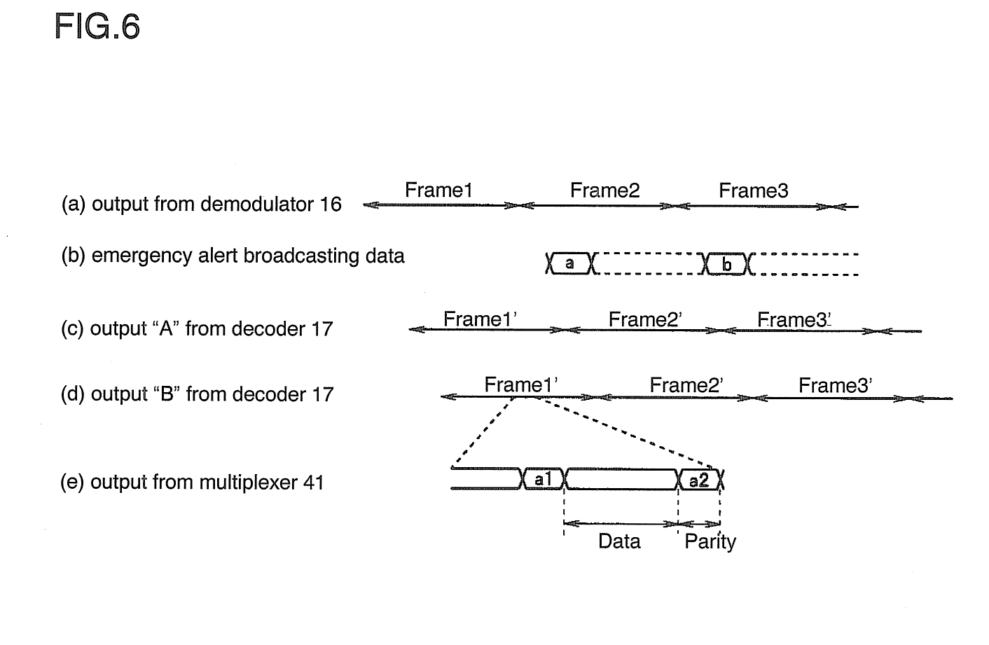

FIG. 6 is an illustration for describing such a timing lag between an OFDM frame from the demodulator 16 and the error corrected OFDM frame from the decoder 17. As shown in outputs A, B of FIG. 6(c) and FIG. 6(d), according to an extent of interleaving, timing of an output from the decoder 17 is shifted with respect to the OFDM frame which is an output from the demodulator 16 as shown in FIG. 6(a). In contrast, in the embodiment, as the emergency alert broadcasting data is extracted from the OFDM frame, which is an output from the demodulator 16, the emergency alert broadcasting data is obtained in synchronization with the OFDM frame, as shown in signs a, b in FIG. 6(b).

In other words, timing at which the emergency alert broadcasting data is obtained does not correspond to the timing of the TS output signal from the decoder 17. Thus, as shown in FIGS. 6(b), (e), the emergency alert broadcasting data a obtained from a predetermined OFDM frame may be divided into 2 portions a1, a2, and each of the portions a1, a2 may be multiplexed onto the parity period of an incorrect TS output. In this case, it is possible that the backend processor 25 cannot normally perform the processing based on the emergency alert broadcasting data.

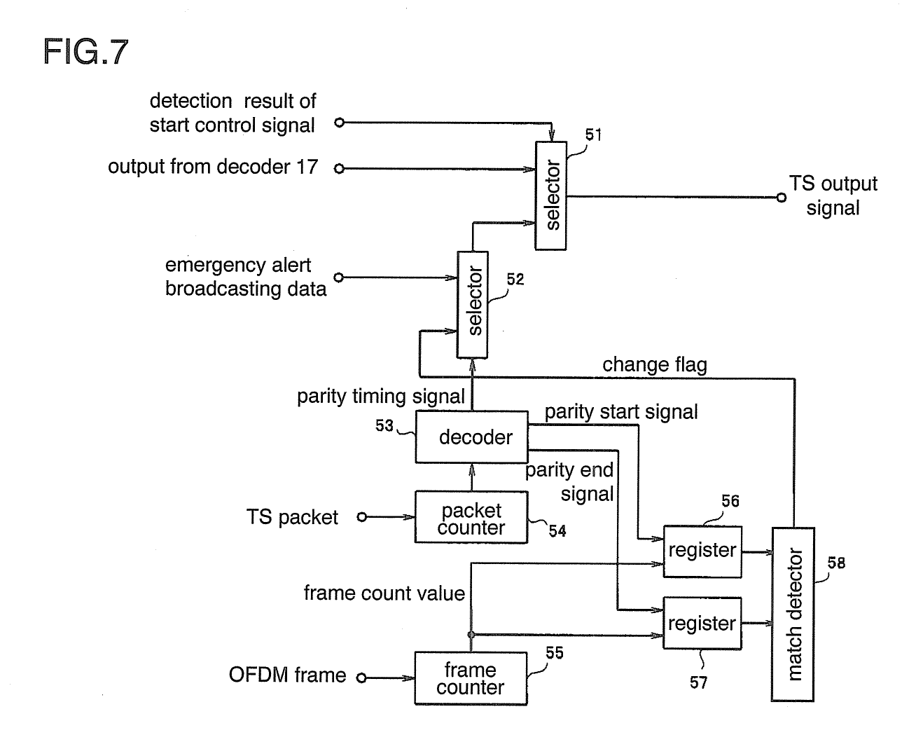

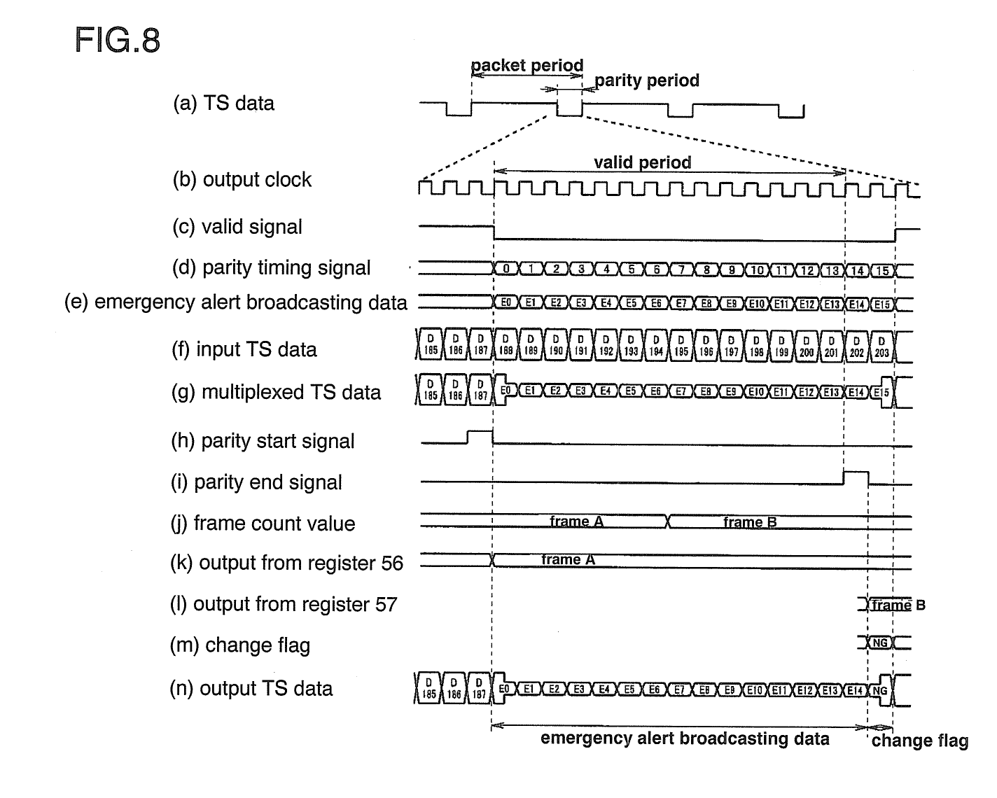

FIG. 7 is a block diagram showing a specific configuration of the multiplexer 41 of FIG. 5. The circuit of FIG. 7 is made to solve the problem of FIG. 6. In addition, FIG. 8 is a timing chart for showing the operation of the circuit of FIG. 7.

In the multiplexer 41 shown in FIG. 7, emergency alert broadcasting data is supplied to a selector 52 from the data readout register 22. The selector 52 outputs the emergency alert broadcasting data to a selector 51 to multiplex the emergency alert broadcasting data onto the parity period of the TS packet, in response to a parity timing signal to be described later. The TS data (input TS data) from the decoder 17 and the emergency alert broadcasting data from the selector 52 are supplied to the selector 51. When a start control signal “1” is detected, the selector 51 inserts the emergency alert broadcasting data in the parity period of the TS data and outputs the data as the TS output signal.

FIG. 8(a) to (g) show the operation. FIG. 8(a) shows TS data from the decoder 17. As described above, 1 packet of the TS data consists of 204 bytes, leading 188 bytes being a data period and last 16 bytes being a parity period. FIG. 8(b) and subsequent parts each show the parity period having the time axis expanded. A valid signal (FIG. 8(c)) showing the parity period specifies an insertion period of the emergency alert broadcasting data.

An output clock of FIG. 8(b) is a clock of 1 byte cycle for the TS data. A parity timing signal (FIG. 8(d)) is generated in synchronization with the output clock. In response to the parity timing signal, the selector 52 outputs the emergency alert broadcasting data from the data readout register 22 to the selector 51 (FIG. 8(e)).

The selector 51 receives the input TS data shown in FIG. 8(f), and when the start control signal “1” is detected, the selector 51 multiplexes the emergency alert broadcast data to the parity period of the input TS data. Accordingly, as shown in FIG. 8(g), the TS output obtained by multiplexing the emergency alert broadcasting data onto the parity period is obtained.

Furthermore, in order to solve the problem of FIG. 6, the multiplexer 41 detects a change-point of the OFDM frame. Specifically, referring to FIG. 7, a frame signal which is generated by the demodulator 16 for every OFDM frame is inputted into a frame counter 55. The frame counter 55 counts frame signals and outputs frame count values to registers 56, 57. On the one hand, a packet signal which is generated by the decoder 17 for every TS packet is inputted into the packet counter 54.

The packet counter 54 counts the packet signals and outputs the count to a decoder 53. Based on the number of clocks from start of the packet period, the decoder 53 generates a parity timing signal during the parity period and outputs the parity timing signal to the selector 52. Furthermore, the decoder 53 generates a parity start signal (FIG. 8(h)) rising at the start timing of the parity period, and outputs the parity start signal to the register 56. In addition, the decoder 53 generates a parity end signal (FIG. 8(i)) falling at the last output clock of the parity period, and outputs the parity end signal to a register 57.

The register 56 captures a frame counter value at the timing of the parity start signal and outputs the parity start signal (FIG. 8(k)). In addition, the register 57 captures a frame count value at the timing of the parity end signal and outputs the parity end signal (FIG. 8(l)). In other words, a first frame count value of the parity period is outputted from the register 56, and a last frame count value of the parity period is outputted from the register 57. A match detector 58 detects whether or not frame count values from the registers 56, 57 match each other. Specifically, when the two frame count values are OFDM frames different from each other, the match detector 58 outputs a change flag showing a mismatch to the selector 52 at the timing of a last output clock of the parity period. Upon reception of the change flag from the match detector 58, the selector 52 outputs the change flag instead of the emergency alert broadcasting data, at the timing of the last output clock of the parity period.

Now, the output OFDM frame from the demodulator 16 is switched in the parity period of the TS data from the decoder 17. In this case, as shown in FIG. 8(j), the frame count value of the frame counter 55 changes at the switching timing of the two OFDM frames A, B.

The register 56 captures the frame count value at the parity start signal, and outputs the frame count value. In this case, the frame count value of the register 56 is a value corresponding to the OFDM frame A (FIG. 8(k)). In addition, the register 57 captures a frame count value in response to the parity end signal and outputs the frame count value. In this case, the frame count value of the register 57 is a value corresponding to the OFDM frame B (FIG. 8(l)).

The match detector 58 detects a match or mismatch between outputs from the registers 56, 57. In this case, since a mismatch occurs, the match detector 58 outputs the change flag (NG) shown in FIG. 8(m). The change flag is supplied to the selector 51 by way of the selector 52.

Thus, in this case, as shown in FIG. 8(n), the TS output is outputted from the selector 51, the TS output having the emergency alert broadcasting data multiplexed onto the leading portion of the parity period and the change flag multiplexed onto the end of the parity period.

Thus, as shown in the embodiment, the emergency alert broadcasting data can be multiplexed correctly to the TS output. This eliminates the need for the controller to read the emergency alert broadcasting data, and thereby enables the reduction of processing of the controller.

Other embodiments or modifications of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. A broadcasting receiver, comprising:
a demodulator to demodulate received digital broadcasting and to output a demodulated signal;
a signal detector to detect a synchronization signal and a start control signal from the demodulated signal, the synchronization signal and the start control signal contained in an emergency alert broadcasting frame multiplexed onto the digital broadcasting, the start control signal indicating emergency alert broadcasting; and
a start flag storage unit to store a start flag indicating that the signal detector has detected the start control signal.

2. The broadcasting receiver of claim 1, further comprising:
an error correction unit to obtain emergency alert broadcasting data contained in the emergency alert broadcasting frame through the signal detector and to perform error correction processing on the emergency alert broadcasting data;
a data storage unit to store the emergency alert broadcasting data having been error-corrected on the basis of error detection by the error correction unit; and
an error flag storage unit to store an error flag based on the error detection by the error correction unit.

3. The broadcasting receiver of claim 2, further comprising:
a match detector to compare emergency alert broadcasting data outputted from the error correction unit with emergency alert broadcasting data outputted from the data storage unit, and to detect whether or not the emergency alert broadcasting data has been updated; and
an update flag storage unit to store an update flag indicating whether or not the match detector has detected updating of the emergency alert broadcasting data.

4. The broadcasting receiver of claim 1, further comprising:
a decoder to output a transport stream by decoding the demodulated signal outputted from the demodulator; and
a multiplexer to multiplex the emergency alert broadcasting data outputted from the data storage unit onto the transport stream from the decoder to obtain a multiplexed data, and to output the multiplexed data, when the signal detector has detected the start control signal.

5. The broadcasting receiver of claim 1 further comprising:
a controller capable of accessing the start flag storage unit, the controller configured to automatically bring a device to present the emergency alert broadcasting, into an operational state when the start flag indicates that the emergency alert broadcasting is being transmitted.

6. A broadcasting receiver, comprising:
a demodulator to demodulate digital broadcasting and to output a demodulated signal;
a signal detector to detect a synchronization signal and a start control signal from the demodulated signal, the synchronization signal and the start control signal contained in an emergency alert broadcasting frame multiplexed onto the digital broadcasting, the start control signal indicating emergency alert broadcasting;
a start flag storage unit to store a start flag indicating that the start control signal has been detected;
an error correction unit to perform error detection and correction of the emergency alert broadcasting data contained in the emergency alert broadcasting frame received through the signal detector;
a data storage unit to store the emergency alert broadcasting data having been error-corrected on the basis of error detection by the error correction unit; and
a controller to multiplex the emergency alert broadcasting data, read from the data storage unit, onto the demodulated signal to obtain a multiplexed data, and to output the multiplexed data, when reading the start flag from the start flag storage unit.

7. The broadcasting receiver of claim 6, wherein
the controller
automatically powers on a circuit immediately after reading the start flag, the circuit forming a broadcast receiving unit having a main power source turned off when the start flag is read, and
stops power supply to the circuit forming the broadcast receiving unit when the error correction circuit detects an error of the emergency alert broadcasting data.

8. The broadcasting receiver of claim 6, further comprising:
a match detector to compare emergency alert broadcasting data outputted from the error correction unit with emergency alert broadcasting data outputted from the data storage unit, and to detect whether or not the emergency alert broadcasting data has been updated; and
an update flag storage unit to store an update flag indicating that the emergency alert broadcast data has been updated,
wherein the controller reads emergency alert broadcasting data stored in the data storage unit, at timing when the controller reads the update flag from the update flag storage unit.

9. The broadcasting receiver of claim 6, further comprising:
a decoder to output a transport stream by decoding the demodulated signal from the demodulator; and
a multiplexer to multiplex the emergency alert broadcasting data read from the data storage unit onto the transport stream from the decoder to obtain the multiplexed data, and to output the multiplexed data, when the signal detector reads the start flag.

10. A broadcasting receiver, comprising:
a signal detector to detect a synchronization signal and a start control signal from a signal obtained by demodulating digital broadcasting, the synchronization signal and the start control signal contained in an emergency alert broadcasting frame multiplexed onto the digital broadcasting, the start control signal indicating emergency alert broadcasting;
a start flag storage unit readable from an external unit, the start flag storage unit configured to store a start flag indicating that the start control signal has been detected;
an error correction unit to perform error detection and correction of the emergency alert broadcasting data contained in the emergency alert broadcasting frame received through the signal detector; and
a data storage unit readable from an external unit, the data storage unit configured to store the emergency alert broadcasting data having been error-corrected on the basis of error detection by the error correction unit.

11. The broadcasting receiver of claim 10, further comprising:
a match detector to compare emergency alert broadcasting data outputted from the error correction unit with emergency alert broadcasting data outputted from the data storage unit, and to detect whether or not the emergency alert broadcasting data has been updated; and
an update flag storage unit readable from an external unit, the update flag storage configured to store an update flag indicating that the emergency alert broadcasting data has been updated.
